(19) United States
(12) Patent Application Publication
(10) Pub. No.: US 2023/0214548 A1
(43) Pub. Date: Jul. 6, 2023

(54) Formation Evaluation Based On Piecewise Polynomial Model

(71) Applicant: Halliburton Energy Services, Inc., Houston, TX (US)

(72) Inventors: Li Pan, Singapore (SG); Hsu-Hsiang Wu, Houston, TX (US); Yi Jing Fan, Singapore (SG); Huiwen Sheng, Singapore (SG)

(73) Assignee: Halliburton Energy Services, Inc., Houston, TX (US)

(21) Appl. No.: 17/570,227

(22) Filed: Jan. 6, 2022

(51) Int. Cl. G06F 30/20; G01V 99/00; E21B 49/00

(52) U.S. Cl. CPC G06F 30/20; G01V 99/005; E21B 49/00; E21B 2200/20; G06F 2111/10

(57) ABSTRACT

A method for formation evaluation may comprise forming one or more model parameters from one or more priori geological information and one or more downhole measurements, identifying one or more inversion controls, and performing a forward model operation using a piecewise polynomial model (PPM). The method may further comprise performing an optimization using at least the forward model operation, the one or more model parameters, and the one or more inversion controls, determining if a misfit between the one or more downhole measurements and the one or more model parameters is greater than or less than a threshold, and updating the forward model operation or the one or more priori geological information based at least in part on the misfit.

### BACKGROUND

Boreholes drilled into subterranean formations may enable recovery of desirable fluids (e.g., hydrocarbons) using a number of different techniques. A downhole tool may be employed in subterranean operations to determine borehole and/or formation properties through logging operations.

Traditionally, during logging operations, an inversion may be performed to evaluate earth formation model, i.e., the distribution of physical property (such as resistivity, permittivity, permeability, etc.) in earth formation. Within the inversion scheme, the earth formation model is updated multiple times according to the difference between measured data and predicted data, where the predicted data is calculated by a simulation which predicts what measurements may be found for the current earth formation model from logging operations. Generally, well logging simulations may be performed based on a piecewise constant model (PCM) of the earth formation.

Currently, PCM is not the exact resistivity distribution, the simulated tool response (EM field, voltage, current) is not accurate enough for some cases. Additionally, PCM simulations are time-consuming because of a large number of unknown parameters are required to build the PCM model for approximating a gradational resistivity profile. Such gradational resistivity profiles will introduce many unknowns in the inversion process, resulting in solution ambiguities and/or inaccurate models from inversion.

### BRIEF DESCRIPTION OF THE DRAWINGS

For a detailed description of the preferred examples of the disclosure, reference will now be made to the accompanying drawings in which:

FIG. 1 illustrates an example of a drilling operation with a downhole tool for one or more downhole measurements;

FIG. 2 illustrates an example of a wireline operation with a downhole tool for one or more downhole measurements;

FIG. 3 illustrates a piecewise constant model (PCM) and a piecewise polynomial model (PPM) and an exact resistivity log;

FIG. 4A illustrates a graph using a PCM inversion;

FIG. 4B illustrates a graph using a piecewise polynomial model (PPM) inversion;

FIG. 5 illustrates a workflow for PPM based inversion;

FIG. 6A illustrates another graph using a PCM inversion; and

FIG. 6B illustrates another graph using a PPM inversion.

### DETAILED DESCRIPTION

The present disclosure relates generally to a system and method for performing a well logging inversion using a simulation scheme based on piecewise constant model (PCM). Such simulations may utilize priori geologic information and processing techniques to predict what measurements may be found from logging operations. The simulated results may be compared to the actual results to determine earth formation model, i.e., the distribution of physical property (such as resistivity, permittivity, permeability, etc.) in earth formation.

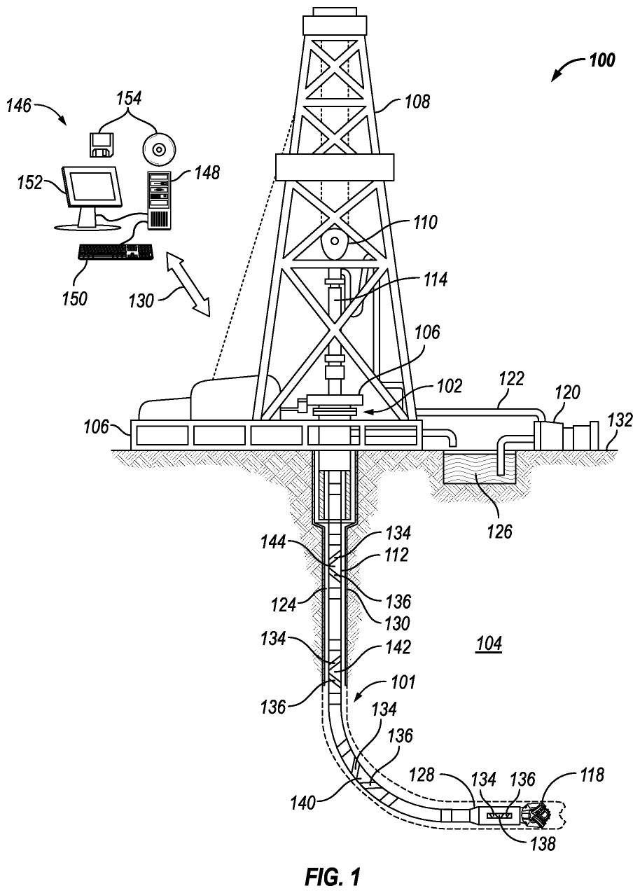

FIG. 1 illustrates a drilling system 100. As illustrated, drilling system 100 may include a drilling platform 106 may support a derrick 108 having a traveling block 110 for raising and lowering drill string 112. Drill string 112 may include, but is not limited to, drill pipe and coiled tubing, as generally known to those skilled in the art. A kelly 114 may support drill string 112 as it may be lowered through a rotary table 116. A drill bit 1218 may be attached to the distal end of drill string 112 and may be driven either by a downhole motor and/or via rotation of drill string 112 from surface 132. Without limitation, drill bit 118 may include, roller cone bits, PDC bits, natural diamond bits, any hole openers, reamers, coring bits, and the like. As drill bit 118 rotates, it may create and extend wellbore 101 that penetrates various subterranean formations 104.

Generally, wellbore 101 may include horizontal, vertical, slanted, curved, and other types of wellbore geometries and orientations. Wellbore 101 may be cased or uncased. In examples, wellbore 101 may include a metallic material. By way of example, the metallic member may be a casing, liner, tubing, or other elongated steel tubular disposed in wellbore 101.

As illustrated, wellbore 101 may extend through subterranean formation 104. As illustrated in FIG. 1, wellbore 101 may extending generally vertically into the subterranean formation 104, however wellbore 101 may extend at an angle through subterranean formation 104, such as horizontal and slanted wellbores. For example, although FIG. 1 illustrates a vertical or low inclination angle well, high inclination angle or horizontal placement of the well and equipment may be possible. It should further be noted that while FIG. 1 generally depicts a land-based operation, those skilled in the art may recognize that the principles described herein are equally applicable to subsea operations that employ floating or sea-based platforms and rigs, without departing from the scope of the disclosure.

With continued reference to FIG. 1, a pump 120 may circulate drilling fluid through a feed pipe 122 to kelly 114, downhole through interior of drill string 112, through orifices in drill bit 118, back to surface 132 via annulus 124 surrounding drill string 112, and into a retention pit 126. Drill string 112 may begin at wellhead 102 and may traverse wellbore 101. Drill bit 118 may be attached to a distal end of drill string 112 and may be driven, for example, either by a downhole motor and/or via rotation of drill string 112 from surface 132. Drill bit 118 may be a part of bottom hole assembly 128 at distal end of drill string 112.

Drilling system 100 may include one or more electromagnetic induction tools, which may be used in a number of downhole induction tools operations, such as measuring-while-drilling (MWD), logging-while-drilling (LWD), wireline logging, and permanent monitoring operations. In examples, without limitation, tubulars may be disposed within the drill collar on a bottom hole assembly, a wireline tool mandrel, and/or permanently installed production casing. For brevity, the metallic tubular may be referred to as a downhole tool below. The electromagnetic antenna in the electromagnetic induction tool may be a magnetometer and/or an induction coil, which may reside on the downhole tool and/or outside. In examples, an electromagnetic source may be an electromagnetic antenna, which may be energized to produce an electromagnetic field. Where used, either the electromagnetic antenna and/or electromagnetic source may reside on the bottom hole assembly and/or outside, even on the surface.

Electromagnetic antennae may record voltages from electromagnetic fields induced by the electromagnetic source. Depending on details of the electromagnetic antenna's design and the size of the computation domain (i.e., mandrel and wellbore lengths) included in an inversion computation, it may take hours to a matter of days to fully compute recorded data from electromagnetic antenna(s). Without limitation, operations that may compute electric and/or magnetic fields may determine the distance and inclination of target well in ranging applications, bed resistivity and distances to bed boundaries in resistivity application, as well as distance to oil-water interface and resistivity change in waterflood monitoring application. Computation of the inversion may include a list of unknown parameters and the accuracy of these parameters may depend on the accuracy of a forward model. Forward models may include full-wave methods which may capture a mandrel (i.e., the supporting structured of the downhole tool) and the wellbore effect accurately.

Electromagnetic well measurement system may include a first downhole tool 138, a second downhole tool 140, a third downhole tool 142, and/or a fourth downhole tool 144 disposed on a conveyance, which may be lowered into wellbore 101. In this disclosure, first downhole tool 138, second downhole tool 140, third downhole tool 142, and/or fourth downhole tool 144 maybe referred to as a downhole tool individually or as a group. In examples, each downhole tool may be separated by about 1 foot (0.3 meter) to about 100 feet (30 meters), about twenty feet (6.096 meters) to about 200 feet (61 meters), or about 50 feet (15 meters) to about 100 (30 meters). It should be noted that electromagnetic well measurement system 100 may include first downhole tool 138. may include an electromagnetic induction tool may be used in a number of downhole induction tools operations, such as measuring-while-drilling (MWD), logging-while-drilling (LWD), wireline logging, and permanent monitoring operations. In examples, without limitation, tubulars may be disposed within the drill collar on a bottom hole assembly, a wireline tool mandrel, and/or permanently installed production casing. For brevity, the metallic tubular may be referred to as a downhole tool below. The electromagnetic antenna in the electromagnetic induction tool may be a magnetometer and/or an induction coil, which may reside on the downhole tool and/or outside. In examples, an electromagnetic source may be an electromagnetic antenna, which may be energized to produce an electromagnetic field. Where used, either the electromagnetic antenna and/or electromagnetic source may reside on the bottom hole assembly and/or outside, even on the surface.

Electromagnetic antennae may record voltages from electromagnetic fields induced by the electromagnetic source. Depending on details of the electromagnetic antenna's design and the size of the computation domain (i.e., mandrel and wellbore lengths) included in an inversion computation, it may take seconds to a matter of days to fully compute recorded data from electromagnetic antenna(s). Without limitation, operations that may compute electric and/or magnetic fields may determine the distance and inclination of target well in ranging applications, bed resistivity and distances to bed boundaries in resistivity application, as well as distance to oil-water interface and resistivity change in waterflood monitoring application. Computation of the inversion may include a list of unknown parameters and the accuracy of these parameters may depend on the accuracy of a forward model. Forward models may include full-wave methods which may capture a mandrel (i.e., the supporting structured of the downhole tool) and the wellbore effect accurately.

With continued reference to FIG. 1, bottom hole assembly 128 may further include first downhole tool 138. First downhole tool 138 may be disposed on the outside and/or within bottom hole assembly 128. It should be noted that second downhole tool 140, third downhole tool 142, and/or fourth downhole tool 144 may be disposed on drill string 112. Second downhole tool 140, third downhole tool 142, and/or fourth downhole tool 144 may be disposed on the outside and/or within drill string 112. First downhole tool 138, second downhole tool 140, third downhole tool 142, and/or fourth downhole tool 144 may include an electromagnetic transmitter 134 and/or an electromagnetic receiver 136. It should be noted that first downhole tool 138, second downhole tool 140, third downhole tool 142, and/or fourth downhole tool 144 may include a plurality of electromagnetic transmitters 134 and/or electromagnetic receivers 136. Electromagnetic transmitters 134 and/or electromagnetic receivers 136 may operate and/or function as electromagnetic antenna, described above. It should be noted that both electromagnetic transmitters 135 and/or electromagnetic receiver 146 may be referred to as antenna. As will be appreciated by those of ordinary skill in the art, first downhole tool 138, second downhole tool 140, third downhole tool 142, and/or fourth downhole tool 144 may be a measurement-while drilling (MWD) or logging-while-drilling (LWD) system.

Without limitation, first downhole tool 138, second downhole tool 140, third downhole tool 142, and/or fourth downhole tool 144, electromagnetic transmitters 134, and/or electromagnetic receiver 136 may be connected to and/or controlled by information handling system 146, which may be disposed on surface 132.

Systems and methods of the present disclosure may be implemented, at least in part, with information handling system 146. Information handling system 146 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 146 may be a personal computer, two or more computers working in a network, a network storage device, or any other suitable device and may vary in size, shape, performance, functionality, and price. Information handling system 146 may include random access memory (RAM), one or more processing resources such as a central processing unit (CPU) 148 or hardware or software control logic, ROM, and/or other types of nonvolatile memory. Additional components of the information handling system 146 may include one or more disk drives, one or more network ports for communication with external devices as well as an input device 150 (e.g., keyboard, mouse, etc.) and output devices, such as a video display 152. Information handling system 146 may also include one or more buses operable to transmit communications between the various hardware components.

Alternatively, systems and methods of the present disclosure may be implemented, at least in part, with non-transitory computer-readable media 154. Non-transitory computer-readable media 154 may include any instrumentality or aggregation of instrumentalities that may retain data and/or instructions for a period of time. Non-transitory computer-readable media 154 may include, for example, storage media such as a direct access storage device (e.g., a hard disk drive or floppy disk drive), a sequential access storage device (e.g., a tape disk drive), compact disk, CD-ROM, DVD, RAM, ROM, and electrically erasable programmable read-only memory (EEPROM), and/or flash memory. In examples, communications media may be used to move information from one non-transitory computer-readable media 154 to another. Communications media may comprise wires, optical fibers, microwaves, radio waves, and other electromagnetic and/or optical carriers; and/or any combination of the foregoing.

Without limitation, information handling system 146 may be disposed downhole in first downhole tool 138, second downhole tool 140, third downhole tool 142, and/or fourth downhole tool 144. Processing of information recorded may occur downhole and/or on surface 132. Processing occurring downhole may be transmitted to surface 132 to be recorded, observed, and/or further analyzed. Additionally, information recorded on information handling system 146 that may be disposed downhole may be stored until first downhole tool 138, second downhole tool 140, third downhole tool 142, and/or fourth downhole tool 144 may be brought to surface 132. In examples, information handling system 146 may communicate with first downhole tool 138, second downhole tool 140, third downhole tool 142, and/or fourth downhole tool 144 through a communication line (not illustrated) disposed in (or on) drill string 112. In examples, wireless communication may be used to transmit information back and forth between information handling system 146 and first downhole tool 138, second downhole tool 140, third downhole tool 142, and/or fourth downhole tool 144. Information handling system 146 may transmit information to first downhole tool 138, second downhole tool 140, third downhole tool 142, and/or fourth downhole tool 144 and may receive as well as process information recorded by first downhole tool 138, second downhole tool 140, third downhole tool 142, and/or fourth downhole tool 144. In examples, a downhole information handling system (not illustrated) may include, without limitation, a microprocessor or other suitable circuitry, for estimating, receiving and processing signals from first downhole tool 138, second downhole tool 140, third downhole tool 142, and/or fourth downhole tool 144. Downhole information handling system (not illustrated) may further include additional components, such as memory, input/output devices, interfaces, and the like. In examples, while not illustrated, first downhole tool 138, second downhole tool 140, third downhole tool 142, and/or fourth downhole tool 144 may include one or more additional components, such as analog-to-digital converter, filter and amplifier, among others, that may be used to process the measurements of first downhole tool 138, second downhole tool 140, third downhole tool 142, and/or fourth downhole tool 144 before they may be transmitted to surface 132. Alternatively, raw measurements from first downhole tool 138, second downhole tool 140, third downhole tool 142, and/or fourth downhole tool 144 may be transmitted to surface 132.

Any suitable technique may be used for transmitting signals from first downhole tool 138, second downhole tool 140, third downhole tool 142, and/or fourth downhole tool 144 to surface 132, including, but not limited to, wired pipe telemetry, mud-pulse telemetry, acoustic telemetry, and electromagnetic telemetry. While not illustrated, first downhole tool 138, second downhole tool 140, third downhole tool 142, and/or fourth downhole tool 144 may include a telemetry subassembly that may transmit telemetry data to surface 132. Without limitation, an electromagnetic source in the telemetry subassembly may be operable to generate pressure pulses in the drilling fluid that propagate along the fluid stream to surface 132. At surface 132, pressure transducers (not shown) may convert the pressure signal into electrical signals for a digitizer (not illustrated). The digitizer may supply a digital form of the telemetry signals to information handling system 146 via a communication link 130, which may be a wired or wireless link. The telemetry data may be analyzed and processed by information handling system 146.

As illustrated, communication link 130 (which may be wired or wireless, for example) may be provided that may transmit data from first downhole tool 138, second downhole tool 140, third downhole tool 142, and/or fourth downhole tool 144 to an information handling system 146 at surface 132. Information handling system 146 may include a central processing unit 148, a video display 152, an input device 150 (e.g., keyboard, mouse, etc.), and/or non-transitory computer-readable media 154 (e.g., optical disks, magnetic disks) that may store code representative of the methods described herein. In addition to, or in place of processing at surface 132, processing may occur downhole.

First downhole tool 138, second downhole tool 140, third downhole tool 142, and/or fourth downhole tool 144 may include an electromagnetic transmitter 134 and/or an electromagnetic receiver 136. In examples, first downhole tool 138, second downhole tool 140, third downhole tool 142, and/or fourth downhole tool 144 may operate with additional equipment (not illustrated) on surface 132 and/or disposed in a separate electromagnetic well measurement system (not illustrated) to record measurements and/or values from subterranean formation 104. During operations, electromagnetic transmitter 134 may broadcast an electromagnetic field from first downhole tool 138, second downhole tool 140, third downhole tool 142, and/or fourth downhole tool 144. Electromagnetic transmitter 134 may be connected to information handling system 146, which may further control the function and/or operation of electromagnetic transmitter 134. Additionally, electromagnetic receiver 136 may sense, measure, and/or record electromagnetic fields broadcasted from electromagnetic transmitter 134. Electromagnetic receiver 136 may transfer recorded information to information handling system 146. Information handling system 146 may control the operation of electromagnetic receiver 136. For example, the broadcasted electromagnetic field from electromagnetic transmitter 134 may be altered (i.e., in phase and attenuation, and/or the like) by subterranean formation 104. The altered electromagnetic field may be recorded by electromagnetic receiver 136 and may be transferred to information handling system 146 for further processing. In examples, there may be any suitable number of electromagnetic transmitters 134 and/or electromagnetic receivers 136, which may be controlled by information handling system 146. Information and/or measurements may be processed further by information handling system 146 to determine properties of wellbore 101, fluids, and/or subterranean formation 104.

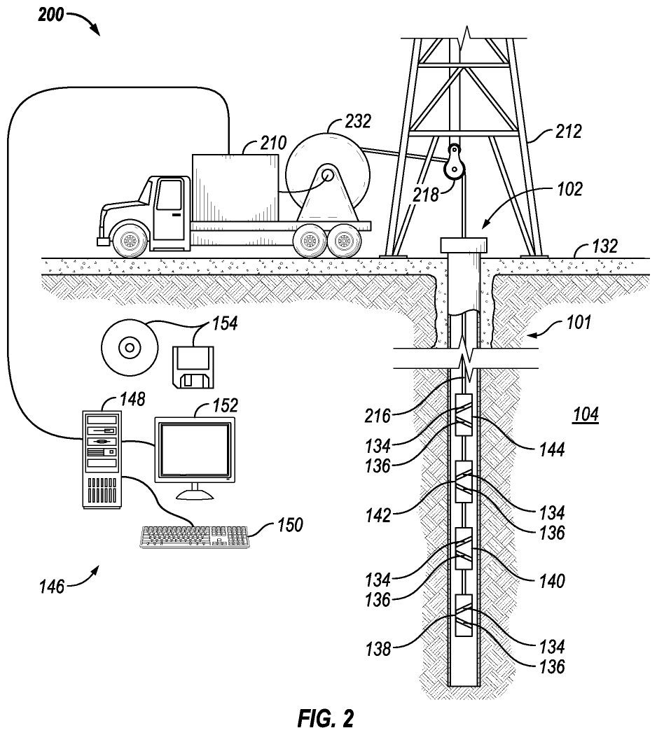

FIG. 2 illustrates a cross-sectional view of an electromagnetic well measurement system 200 which may be disposed in a wellbore 101. As illustrated, wellbore 101 may extend from a wellhead 102 into a subterranean formation 104 from surface 132. As illustrated, electromagnetic well measurement system 100 may include a plurality of downhole electromagnetic tools, such as first downhole tool 138. As illustrated, first downhole tool 138, second downhole tool 140, third downhole tool 142, and/or fourth downhole tool 144 may attach to a vehicle 210. In examples, it should be noted that first downhole tool 138, second downhole tool 140, third downhole tool 142, and/or fourth downhole tool 144 may not be attached to a vehicle 210. First downhole tool 138, second downhole tool 140, third downhole tool 142, and/or fourth downhole tool 144 may be supported by rig 212 at surface 132. First downhole tool 138, second downhole tool 140, third downhole tool 142, and/or fourth downhole tool 144 may be tethered to vehicle 210 through conveyance 216. Conveyance 216 may be disposed around one or more sheave wheels 218 to vehicle 210. Conveyance 216 may include any suitable means for providing mechanical conveyance for first downhole tool 138, second downhole tool 140, third downhole tool 142, and/or fourth downhole tool 144, including, but not limited to, wireline, slickline, coiled tubing, pipe, drill pipe, downhole tractor, or the like. In some embodiments, conveyance 216 may provide mechanical suspension, as well as electrical connectivity, for first downhole tool 138, second downhole tool 140, third downhole tool 142, and/or fourth downhole tool 144. Conveyance 216 may include, in some instances, a plurality of electrical conductors extending from vehicle 210. Conveyance 216 may include an inner core of several electrical conductors covered by an insulating wrap. An inner and outer steel armor sheath may be wrapped in a helix in opposite directions around the conductors. The electrical conductors may be used for communicating power and telemetry between vehicle 210 and first downhole tool 138, second downhole tool 140, third downhole tool 142, and/or fourth downhole tool 144. Information from first downhole tool 138, second downhole tool 140, third downhole tool 142, and/or fourth downhole tool 144 may be gathered and/or processed by information handling system 146. For example, signals recorded by first downhole tool 138, second downhole tool 140, third downhole tool 142, and/or fourth downhole tool 144 may be stored on memory and then processed by first downhole tool 138, second downhole tool 140, third downhole tool 142, and/or fourth downhole tool 144. The processing may be performed real-time during data acquisition or after recovery of first downhole tool 138, second downhole tool 140, third downhole tool 142, and/or fourth downhole tool 144. Processing may alternatively occur downhole or may occur both downhole and at surface. In some embodiments, signals recorded by first downhole tool 138, second downhole tool 140, third downhole tool 142, and/or fourth downhole tool 144 may be conducted to information handling system 146 by way of conveyance 216. Information handling system 146 may process the signals, and the information contained therein may be displayed for an operator to observe and stored for future processing and reference. Information handling system 146 may also contain an apparatus for supplying control signals and power to first downhole tool 138, second downhole tool 140, third downhole tool 142, and/or fourth downhole tool 144.

In examples, rig 212 includes a load cell (not shown) which may determine the amount of pull on conveyance 216 at the surface of wellbore 101. Information handling system 146 may include a safety valve which controls the hydraulic pressure that drives drum 232 on vehicle 210 which may reel up and/or release conveyance 216 which may move first downhole tool 138, second downhole tool 140, third downhole tool 142, and/or fourth downhole tool 144 up and/or down wellbore 101. The safety valve may be adjusted to a pressure such that drum 232 may only impart a small amount of tension to conveyance 216 over and above the tension necessary to retrieve conveyance 216 and/or first downhole tool 138, second downhole tool 140, third downhole tool 142, and/or fourth downhole tool 144 from wellbore 101. The safety valve is typically set a few hundred pounds above the amount of desired safe pull on conveyance 216 such that once that limit is exceeded; further pull on conveyance 216 may be prevented.

In examples, first downhole tool 138, second downhole tool 140, third downhole tool 142, and/or fourth downhole tool 144 may include an electromagnetic transmitter 134 and/or an electromagnetic receiver 136. It should be noted each downhole tool may include a plurality of electromagnetic transmitters 134 and/or a plurality of electromagnetic receivers 136. The plurality of electromagnetic transmitters 134 and the plurality of electromagnetic receiver 136 may be disposed along a longitudinal axis of any downhole tool. As disclosed, the concepts that are described herein are valid for any type of electromagnetic transmitters 134 and electromagnetic receiver 136. As an example, wire antenna, toroidal antenna and/or azimuthal button electrodes, electromagnetic transmitter coils, and/or electromagnetic receiver coils may also be used in the place of the electromagnetic transmitters 134 and/or electromagnetic receiver 136. In some examples, electromagnetic receiver 136 may include an electromagnetic transmitter, an electromagnetic receiver, or a transceiver. Without limitation, electromagnetic transmitters 134 and/or electromagnetic receiver 136 may be disposed on and/or adjacent to a gap sub. In examples, there may be more than one gap sub in which electromagnetic transmitters 134 and/or electromagnetic receiver 136 may be disposed on and/or adjacent to.

Additionally, electromagnetic transmitter 134 may operate and function to broadcast an electromagnetic field. In examples, electromagnetic transmitter 134 may broadcast a low frequency electromagnetic field and/or a high frequency electromagnetic field. A low frequency electromagnetic field, wherein the low frequency electromagnetic field may range from about 1 KHz to about 250 KHz. Electromagnetic transmitter 134 may also broadcast a high frequency electromagnetic field, which may range from about 250 KHz to about 2 MHz. Electromagnetic transmitter 134 may broadcast the high frequency electromagnetic field and the low frequency electromagnetic field on any number of frequencies along any number of channels sequentially and/or simultaneously on the same antenna and/or multiple antennas. In examples, first downhole tool 138, second downhole tool 140, third downhole tool 142, and/or fourth downhole tool 144 may operate with additional equipment (not illustrated) on surface 132 and/or disposed in a separate electromagnetic well measurement system (not illustrated) to record measurements and/or values from formation 105. During operations, electromagnetic transmitter 134 may broadcast the high frequency electromagnetic field or the low frequency electromagnetic field from first downhole tool 138, second downhole tool 140, third downhole tool 142, and/or fourth downhole tool 144. Electromagnetic transmitter 134 may be connected to information handling system 146, which may further control the function and/or operation of electromagnetic transmitter 134. Additionally, electromagnetic receiver 136 may measure and/or record electromagnetic fields broadcasted from electromagnetic transmitter 134. Electromagnetic receiver 136 may transfer recorded information to information handling system 146. Information handling system 146 may control the operation of electromagnetic receiver 136. For example, the broadcasted electromagnetic field from electromagnetic transmitter 134 may be altered (i.e., in phase and attenuation, and/or the like) by formation 105, which may be sensed, measured, and/or recorded by electromagnetic receiver 136. It should be noted that electromagnetic transmitter 134 and electromagnetic receiver 136 may be the same antenna, coil, toroid, and/or the like. The recorded signal may be transferred to information handling system 146 for further processing.

In examples, there may be any suitable number of electromagnetic transmitters 134 and/or electromagnetic receivers 136, which may be controlled by information handling system 146. Information and/or measurements may be processed further by information handling system 146 to determine properties of wellbore 101, fluids, and/or formation 104.

During electromagnetic logging operations, deep electromagnetic measurements, which may be found using low frequency electromagnetic fields, may be fed into an inversion together with shallow measurements, which may be found using high frequency electromagnetic fields. The inversion may produce a formation resistivity model. Without limitations, deep electromagnetic measurements may be measurements that may be able to measure formation properties that are more than 10 feet (3 meters) away and shallow electromagnetic measurements may be measurements that are sensitive to formation properties within a range of about 10 feet (3 meters).

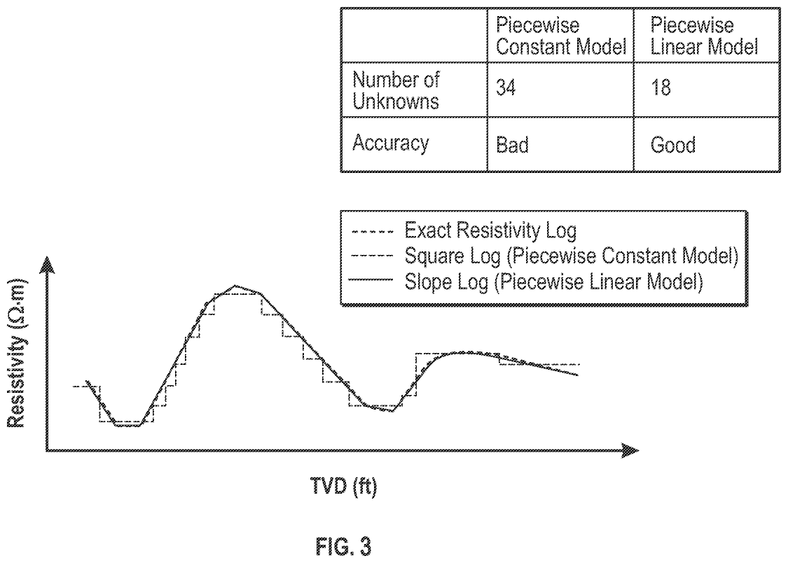

FIG. 3 illustrates an exact distribution of resistivity log, and its approximation with Piecewise Constant Model (PCM), and its approximation with a Piecewise Polynomial Model (PPM). With PPM, utilizing a PCM or square log has disadvantages. For example, PCM does not produce an exact resistivity distribution, and therefore the predicted measurements based on PCM, (i.e., simulated tool responses (EM field, voltage, current) from the downhole tools) are not accurate enough. Additionally, evaluation of predicted data for a PCM is time-consuming due to many unknown parameters that are required to build the PCM model for approximating a gradational resistivity profile. Such gradational resistivity profiles will introduce many unknowns in the inversion process, resulting in solution ambiguities and/or inaccurate inversion results.

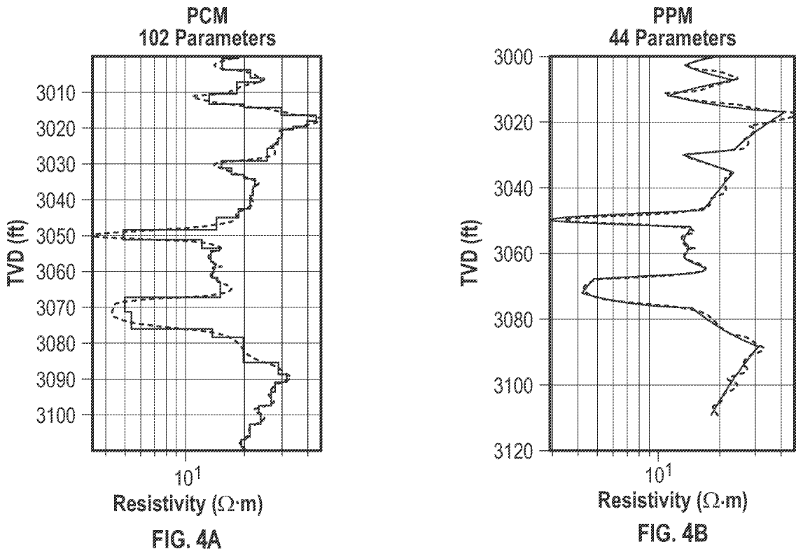

With continued reference to FIG. 3, the disadvantages in using a PCM are overcome by utilizing a piecewise polynomial model (PPM) instead of a PCM. This reduces the number of unknowns in the inversion, provides better approximation for the gradational resistivity profiles, and produces a more reliable and robust inversion model. A PPM may also be referred to as a piecewise polynomial model. FIG. 4 illustrates how a PCM and a PPM log from inversion using simulated measurements may follow an exact resistivity log with real measurements. It should be noted that a PCM is an example processing technique for PPM with zero degree, meaning PPM may be able to cover the PCM cases if real formations are PCM models.

Table 1 below is utilized for further explanation of PCM vs PPM.

TABLE 1

| Type # | Parameters | Notation |
|---|---|---|
| 1 | TVD points at the boundary between | d₁, d₂, . . . , d_{N}_{ₛ}₋₁ |
| | neighboring sections. | |
| 2 | Relative dip angles and relative azimuth | θ, β |
| | angles | |
| 3 | Polynomial parameters for each section | aₙ^{m} |
| | | m = 1, . . . , Nₛ |
| | | n = 0, 1, . . . , Pₘ |
| 4 | Number of sections in the PPM | Nₛ |
| 5 | Degree of the polynomial model for m-th | Pₘ |
| | section | |

For PCM, the whole range of TVD may be divided into Nₛ sections. The whole range is defined as a model to approximate at least a portion of formation 104 (e.g., referring to FIG. 1). In examples the model approximates the part of formation 104 that is part of the depth of investigation for the downhole tool. For the n-th section (for Nₛ sections), the resistivity may be defined as a constant Rₙ

R(d)=Rₙ if dₙ₋₁<d<dₙ (1)

For PPM, the whole range of TVD is divided into Nₛ sections, for the n-th section, the resistivity may be defined as R that is a function of depth

R(d)=a₀+a₁d+a₂d²+ . . . +a_{P}_{ₙ}d^{P}^{ₙ} if dₙ₋₁<d<dₙ (2)

As noted above, from Equations (1) and (2), PCM is an example case for PPM where the 0th degree. As noted above, PCM model has been widely utilized in the simulation and inversion of real resistivity log of formation. Unfortunately, the real distribution of resistivity in formation 104 is far from a PCM model, as illustrated in FIGS. 4A and 4B. FIG. 4A illustrates a PCM utilizing simulated data overlayed on real resistivity measurements. FIG. 4B illustrates a PPM utilizing simulated data overlayed on real resistivity measurements. As illustrated in FIG. 4A, PCM is a poor model for real resistivity distribution of formation 104 (e.g., referring to FIG. 1). Therefore, the simulated tool response (EM field, voltage, current) is inaccurate. PCM requires too many unknown parameters (i.e., one hundred and two individual parameters in this case), while PPM (e.g., referring to FIG. 4B) utilizes fewer unknowns (i.e., forty-four individual parameters in this case), as a result the simulation for PCM is more time-consuming. An increase in unknowns may cause processing using inversion to become even more ill-posed, so the quality of answer product is reduced.

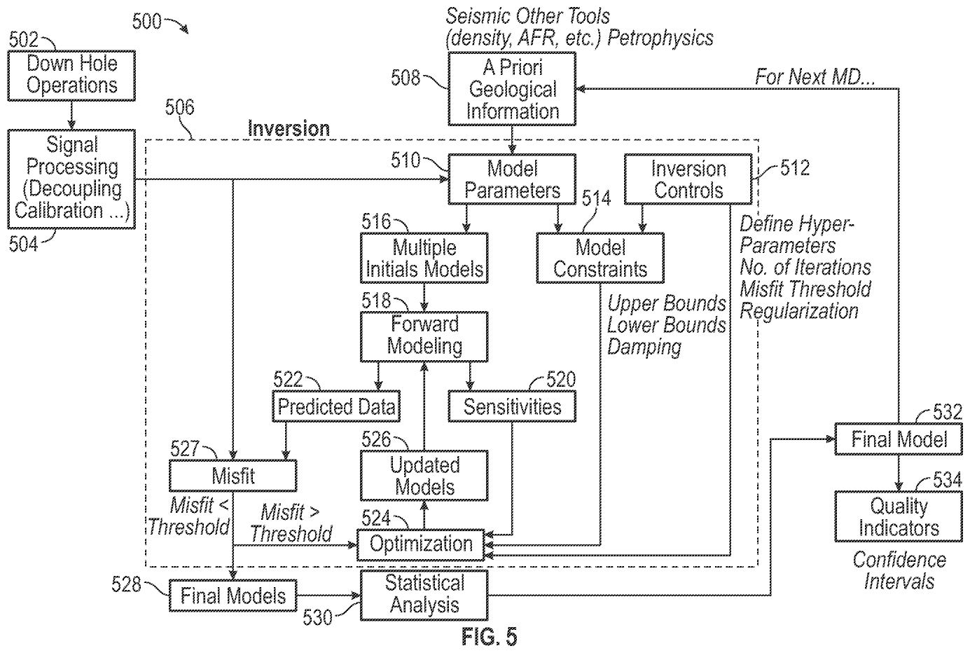

FIG. 5 illustrates workflow 500 for a PPM based inversion. Workflow 500 may begin with block 502, in which downhole operations may be performed. During downhole operations one or more measurements may be taken utilizing one or more downhole tools. The downhole tools may take resistivity measurements, electromagnetic (EM) measurements, and/or the like. Measurements taken in block 502 may be taken in block 504 and further processed using signal processing techniques. An inversion 506 may take processed signals from block 504 and priori geological information from block 508 to form a model.

For inversion 506, Table 2 may be referred to:

TABLE 2

| Parameters | |
|---|---|
| W̅_{d} | Information of estimated uncertainty in measured data due to noise |
| ē(x̅) | Error = measurement − simulation (i.e., a misfit between one or more |
| | downhole measured data and one or more predicted data) |
| μ | Regularization coefficient |
| a | Regularization coefficient |
| X² | Estimates of data noise |
| W̅ₓ | Information of degree of confidence in prescribed model parameters |
| x̅ₚ | A vector of a prescribed model parameters |
| x̅ | A vector of model parameters (physical property and polynomial coefficients) |

With continued reference to FIG. 5, processed data from block 504 and prior geological information from block 508 may be utilized in to determine model parameters in block 510. Model parameters found in block 510 may be physical properties such as resistivity, dielectric constants, magnetic permeability. Additionally, in block 512, inversion controls may be identified as hyper-parameters. Hyper-parameters found in block 512 may include number of iterations, misfit threshold, initial solution for optimization, and/or regularization coefficients. In examples, the hyper-parameters may be configured for numerical optimization. The cost function for inversion 506 is performed in block 520, discussed in further detail below, when determining sensitivities. Specifically,

$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2} \qquad ( 3 )$$

The parameters in the cost function are defined in Table 2. In other examples the hyper-parameters may also be obtained by optimization. For this approach, the global optimization may be employed, and a new cost function is defined as below, by minimizing Pₘ the polynomial models may be simplified, which may prevent over-fitting:

$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2} + a {\sum }_{m = 1}^{{N}_{s}} {P}_{m} \qquad ( 4 )$$

n this cost function, a new regularization term may be added to limit the order of each polynomial, a is the coefficient for the new regularization term, and Nₛ is a number of sections in the model. Utilizing model parameters from block 510 and inversion controls from block 512, model constraints may be found in block 514. Model constraints in block 514 may be set by personnel. For example, constraints may be upper and lower bounds for resistivity based on prior information (such as the knowledge of geophysics, or other info). Additionally, the model parameters found in block 510 may be utilized to form multiple initial models in block 516. Initial models in block 516 may be a multi-layer formation model generated by randomly sampling different sets of formation parameters such that the generated models cover all possible parameters for the multiple formation layers of interest. Such sampling may be performed using any of various statistical techniques, e.g., based on a predefined range of parameters within some probability distribution. Using the initial models found in block 516, a forward modeling operation, in which the predicted data and Jacobian matrix is evaluated, may be performed in block 518. For example, model parameters are determined by either deterministic optimization or global optimization. If deterministic optimization is chosen, sensitivity of measured responses is found in block 520, discussed in more detain below, with respect to each model parameter. All sensitivity information used in block 520 form a Jacobian matrix. In examples, two methods for forward modeling may be utilized. In the first method, a semi-analytical solution for each section may be derived using Equation (5) below:

Hᵢ=∫₀^{∞}dα[αJ₀(αρ)(Ŝᵢ+\hat{T}ᵢ)]+∫₀^{∞}dα[J₁(αρ)(\hat{P}ᵢ+\hat{Q}ᵢ)] (5)

After that all the reflection and transmission coefficients (Ŝᵢ, \hat{T}ᵢ, \hat{P}ᵢ, \hat{Q}ᵢ) are calculated by applying the boundary condition. The boundary condition is defined as a continuation electric and magnetic fields applied to a boundary in formation 104. Finally, the tool response (Hᵢ) and Jacobian matrix is calculated by Hankel transform.

In the second method, the PPM is converted to a PCM with a large number (i.e., three hundred) of layers with equal or unequal thickness. Then the predicted data and Jacobian matrix are calculated with the PCM method. Although this method also involves PCM, it differs from the existing PCM-based method in that the number of unknowns is greatly reduced. As only the polynomial coefficients may be specified instead of the resistivity for each PCM layer, as a result, the size of Jacobian matrix is small, and the computation cost is low. The forward modeling solver built by the first solver is much faster, but only polynomial models with low order are feasible. The forward modeling solver built by the second solver is slower, but easy to implement and is feasible for any polynomial models.

From the forward model operation in block 518, sensitivities in block 520 and predicted data in block 522 may be found. Sensitivities in block 520 may be found by the derivative of this cost function of Equation (3), with respect to each model parameters, discussed above. In block 522, predicted data may be found by performing a forward simulation for that forward model found in block 518 to identify predicted data. Using sensitivities from block 520, model constraints in block 514, and inversion controls in block 512 an optimization is performed in block 524. Optimization utilized in block 512 may be a line search numerical optimization methods or trust region optimization methods, such as steepest descent, Gauss-Newton. In block 526, an updated model may be utilized as an input in block 518 to update and further refine forward modeling operations. In block 527, a misfit may be found utilizing the processed signals from block 504 and the predicted data in block 522. A misfit may be found in block 527 by solving for ē(x̅), defined in Table 2, and solved for in Equations (3) and (4) above. If the misfit is smaller than a threshold, the threshold being chosen by personnel, then the current model parameters may be identified as a solution, otherwise optimization may continue. If the misfit is greater than the threshold, the process in block 524 is update and performed again, using the methods and systems described above. In block 530 a statistical analysis is performed on the final models found in block 528. The statistical analysis may be performed on multiple solutions from block 528, give the statistics such as, a mean, a standard deviation, a percentile, a confidence interval, and/or the like. Final models in block 532 are formed from the statistical analysis in block 528. In block 534, final models from block 532 may have a quality check using quality indicators. For example, quality indicators may be a standard deviation or a confidence interval that is smaller than a threshold chosen by personnel. Such results may indicate that the inversion results are accurate. It should be noted that the final models in block 532 may be used to update the information in block 508.

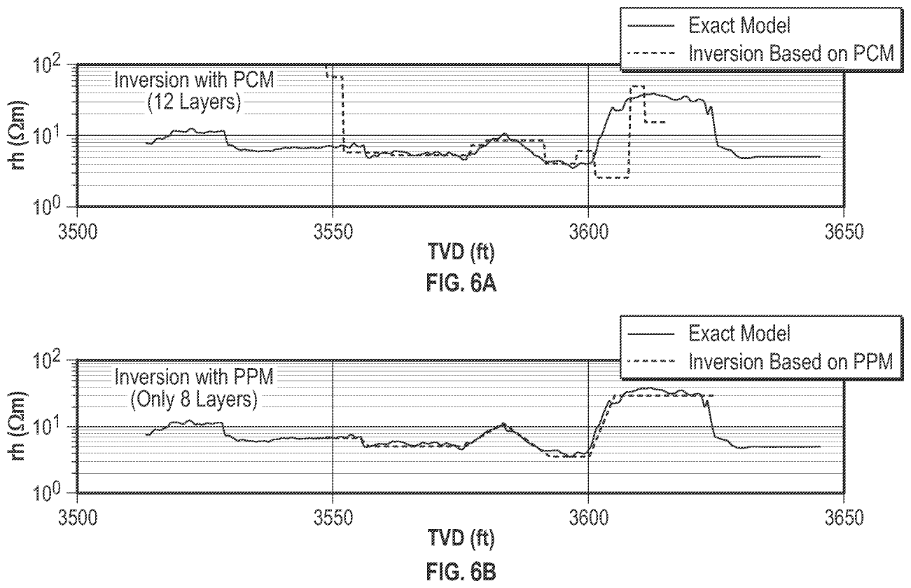

FIGS. 6A and 6B illustrate implementations of workflow 500 using PCM and PPM, respectfully. In this example, raw measurements may be converted to five tensor components Zₓₓ, Z_{yy}, Z_{zz}, Z_{xz}, Z_{zx}. Using workflow 500, an inversion based on both PCM and PPM may be performed. FIG. 6A illustrates the PCM inversion and FIG. 6B illustrates the PPM inversion. As illustrated in FIG. 6A, the resistivity log inverted based on PCM is only a good approximation within a depth of investigation (DOI) of about 15 feet (about 3.5 meters) and may be unreliable beyond that range. FIG. 6B illustrates the resistivity log inverted based on PPM. The resistivity log inverted based on PPM is nearly an exact fit to the modeled data.

From the methods and systems described above, improvements over current technology may comprise more realistic model approximation for real formation resistivity profiles, resulting more accurate modeling simulation. Additionally, improvements may be found in lower computational cost in both forward modeling and inversion owing to the fewer unknown variables of PPM model, better inversion convergency since it is closer to the real formation resistivity profiles, and a novel answer product which is not available from existing technology, such as the gradational resistivity profiles. The systems and methods may include any of the various features of the systems and methods disclosed herein, including one or more of the following statements.

Statement 1. A method may comprise forming one or more model parameters from one or more priori geological information and one or more downhole measurements, identifying one or more inversion controls, and performing a forward model operation using a piecewise polynomial model (PPM). The method may further comprise performing an optimization using at least the forward model operation, the one or more model parameters, and the one or more inversion controls, determining if a misfit between the one or more downhole measurements and the one or more model parameters is greater than or less than a threshold, and updating the forward model operation or the one or more priori geological information based at least in part on the misfit.

Statement 2. The method of statement 1, further comprising forming one or more initial models from the model parameters to be utilizing the forward modeling operation.

Statement 3. The method of statement 2, wherein the model parameters are determined by deterministic optimization or global optimization.

Statement 4. The method of statement 3, wherein the one or more initial models are a multi-layer formation model generated by randomly sampling different sets of formation parameters.

Statement 5. The method of any preceding statements 1 or 2, wherein the optimization uses a cost function.

Statement 6. The method of statement 5, wherein the cost function is:

$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2}$$

and wherein, (W̅_{d}^{T}W̅_{d})⁻¹ is estimated uncertainty in measured data due to noise, ē(x̅) is a misfit between one or more downhole measurements and one or more modeled parameters, μ is a regularization coefficient, χ² is an estimate of data noise, (W̅ₓ^{T}W̅ₓ)⁻¹ is a degree of confidence in prescribed model parameters, x̅ₚ is a vector of prescribed model parameters, and x̅ is a vector of model parameters.

Statement 7. The method of claim 5, wherein the cost function is:

$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2} + a {\sum }_{m = 1}^{{N}_{s}} {P}_{m}$$

and wherein, (W̅_{d}^{T}W̅_{d})⁻¹ is estimated uncertainty in measured data due to noise, ē(x̅) is a misfit between one or more downhole measurements and one or more modeled parameters, μ is a regularization coefficient, χ² is an estimate of data noise, (W̅ₓ^{T}W̅ₓ)⁻¹ is a degree of confidence in a prescribed model parameter, x̅ₚ is a vector of prescribed model parameters, x̅ is a vector of model parameters, a is a regularization coefficient, Nₛ is a number of sections in the model, and Pₘ is the degree of polynomial.

Statement 8. The method of any preceding statements 1, 2, or 5, further comprising identifying one or more sensitivities from the forward model operation.

Statement 9. The method of any preceding statements 1, 2, 5, or 8, further comprising identifying one or more model constraints from the one or more inversion controls and the one or more model parameters.

Statement 10. The method of any preceding statements 1, 2, 5, 8, or 9, wherein the forward model operation uses a Jacobian process.

Statement 11. A system for formation evaluation may comprise a downhole tool. The donwhole tool may comprise a transmitter disposed on the downhole tool and configured to transmit an electormagnetic field and a receiver disposed on the downhole tool and configured to take one or more downhole measurements. The system may further comprise an information handling system communicatively connected to the downhole tool and configured to form one or more model parameters from one or more priori geological information and one or more processed data, identify one or more inversion controls, perform a forward model operation using a piecewise polynomial model (PPM), perform an optimization using the forward model operation, the one or more model parameters, and the one or more inversion controls, determining if a misfit between the one or more downhole measurements and the one or more model parameters is greater than or less than a threshold, and update the forward model operation or the one or more priori geological information based at least in part on the misfit.

Statement 12. The system of any statement 11, wherein the information handling system is further configured to form one or more initial models from the model parameters to be utilizing the forward modeling operation.

Statement 13. The system of statement 12, wherein the model parameters are determined by deterministic optimization or global optimization.

Statement 14. The system of statement 13, wherein the one or more initial models are a multi-layer formation model generated by randomly sampling different sets of formation parameters.

Statement 15. The system of any preceding statements 11 or 12, wherein the optimization uses a cost function.

Statement 16. The system of statement 15, wherein the cost function is:

$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2}$$

and wherein, (W̅_{d}^{T}W̅_{d})⁻¹ is estimated uncertainty in measured data due to noise, ē(x̅) is a misfit between one or more downhole measurements and one or more modeled parameters, μ is a regularization coefficient, χ² is an estimate of data noise, (W̅ₓ^{T}W̅ₓ)⁻¹ is a degree of confidence in prescribed model parameters, x̅ₚ is a vector of prescribed model parameters, and x is a vector of model parameters.

Statement 17. The system of statement 15, wherein the cost function is:

$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2} + a {\sum }_{m = 1}^{{N}_{s}} {P}_{m}$$

and wherein, (W̅_{d}^{T}W̅_{d})⁻¹ is estimated uncertainty in measured data due to noise, ē(x̅) is a misfit between one or more downhole measurements and one or more modeled parameters, μ is a regularization coefficient, χ² is an estimate of data noise, (W̅ₓ^{T}W̅ₓ)⁻¹ is a degree of confidence in prescribed model parameters, x̅ₚ is a vector of prescribed model parameters, x̅ is a vector of model parameters, a is a regularization coefficient, Nₛ is a number of sections in the model, and Pₘ is the degree of polynomial.

Statement 18. The system of any preceding statements 11, 12, or 15, wherein the information handling system is further configured to identify one or more sensitivities from the forward model operation.

Statement 19. The system of any preceding statements 11, 12, 15, or 18, wherein the information handling system is further configured to identify one or more model constraints from the one or more inversion controls and the one or more model parameters.

Statement 20. The system of any preceding statements 11, 12, 15, 18, or 19, wherein the forward model operation uses a Jacobian process.

Although the present disclosure and its advantages have been described in detail, it should be understood that various changes, substitutions and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
forming one or more model parameters from one or more priori geological information and one or more downhole measurements;
identifying one or more inversion controls;
performing a forward model operation using a piecewise polynomial model (PPM);
performing an optimization using at least the forward model operation, the one or more model parameters, and the one or more inversion controls;
determining if a misfit between the one or more downhole measurements and the one or more model parameters is greater than or less than a threshold; and
updating the forward model operation or the one or more priori geological information based at least in part on the misfit.

2. The method of claim 1, further comprising forming one or more initial models from the model parameters to be utilizing the forward modeling operation.

3. The method of claim 2, wherein the model parameters are determined by deterministic optimization or global optimization.

4. The method of claim 3, wherein the one or more initial models are a multi-layer formation model generated by randomly sampling different sets of formation parameters.

5. The method of claim 1, wherein the optimization uses a cost function.

6. The method of claim 5, wherein the cost function is:
$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2}$$
and wherein, (W̅_{d}^{T}W̅_{d})⁻¹ is estimated uncertainty in measured data due to noise, ē(x̅) is a misfit between one or more downhole measurements and one or more modeled parameters, μ is a regularization coefficient, χ² is an estimate of data noise, (W̅ₓ^{T}W̅ₓ)⁻¹ is a degree of confidence in prescribed model parameters, x̅ₚ is a vector of prescribed model parameters, and x̅ is a vector of model parameters.

7. The method of claim 5, wherein the cost function is:
$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2} + a {\sum }_{m = 1}^{{N}_{s}} {P}_{m}$$
and wherein, (W̅_{d}^{T}W̅_{d})⁻¹ is estimated uncertainty in measured data due to noise, ē(x̅) is a misfit between one or more downhole measurements and one or more modeled parameters, μ is a regularization coefficient, χ² is an estimate of data noise, (W̅ₓ^{T}W̅ₓ)⁻¹ is a degree of confidence in a prescribed model parameter, x̅ₚ is a vector of prescribed model parameters, x̅ is a vector of model parameters, a is a regularization coefficient, Nₛ is a number of sections in the model, and Pₘ is the degree of polynomial.

8. The method of claim 1, further comprising identifying one or more sensitivities from the forward model operation.

9. The method of claim 1, further comprising identifying one or more model constraints from the one or more inversion controls and the one or more model parameters.

10. The method of claim 1, wherein the forward model operation uses a Jacobian process.

11. A system comprising:
a downhole tool comprising:
a transmitter disposed on the downhole tool and configured to transmit an electormagnetic field; and
a receiver disposed on the downhole tool and configured to take one or more downhole measurements; and
an information handling system communicatively connected to the downhole tool and configured to:
form one or more model parameters from one or more priori geological information and one or more processed data;
identify one or more inversion controls;
perform a forward model operation using a piecewise polynomial model (PPM);
perform an optimization using the forward model operation, the one or more model parameters, and the one or more inversion controls;
determining if a misfit between the one or more downhole measurements and the one or more model parameters is greater than or less than a threshold; and
update the forward model operation or the one or more priori geological information based at least in part on the misfit.

12. The system of claim 11, wherein the information handling system is further configured to form one or more initial models from the model parameters to be utilizing the forward modeling operation.

13. The system of claim 12, wherein the model parameters are determined by deterministic optimization or global optimization.

14. The system of claim 13, wherein the one or more initial models are a multi-layer formation model generated by randomly sampling different sets of formation parameters.

15. The system of claim 11, wherein the optimization uses a cost function.

16. The system of claim 15, wherein the cost function is:
$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2}$$
and wherein, (W̅_{d}^{T}W̅_{d})⁻¹ is estimated uncertainty in measured data due to noise, ē(x̅) is a misfit between one or more downhole measurements and one or more modeled parameters, μ is a regularization coefficient, χ² is an estimate of data noise, (W̅ₓ^{T}W̅ₓ)⁻¹ is a degree of confidence in prescribed model parameters, x̅ₚ is a vector of prescribed model parameters, and x̅ is a vector of model parameters.

17. The system of claim 15, wherein the cost function is:
$$C ( \overline{x} ) = \frac{1}{2} μ [ {‖ {\overline{\overline{W}}}_{d} \cdot \overline{e} ( \overline{x} ) ‖}^{2} - {χ}^{2} ] + \frac{1}{2} {‖ {\overline{\overline{W}}}_{x} \cdot ( \overline{x} - {\overline{x}}_{p} ) ‖}^{2} + a {\sum }_{m = 1}^{{N}_{s}} {P}_{m}$$
and wherein, (W̅_{d}^{T}W̅_{d})⁻¹ is estimated uncertainty in measured data due to noise, ē(x̅) is a misfit between one or more downhole measurements and one or more modeled parameters, μ is a regularization coefficient, χ² is an estimate of data noise, (W̅ₓ^{T}W̅ₓ)⁻¹ is a degree of confidence in prescribed model parameters, x̅ₚ is a vector of prescribed model parameters, x̅ is a vector of model parameters, a is a regularization coefficient, Nₛ is a number of sections in the model, and Pₘ is the degree of polynomial.

18. The system of claim 11, wherein the information handling system is further configured to identify one or more sensitivities from the forward model operation.

19. The system of claim 11, wherein the information handling system is further configured to identify one or more model constraints from the one or more inversion controls and the one or more model parameters.

20. The system of claim 11, wherein the forward model operation uses a Jacobian process.
